(19) United States
(12) Patent Application Publication
(10) Pub. No.: US 2005/0050400 A1
(43) Pub. Date: Mar. 3, 2005

(54) Shift redundancy encoding for use with digital memories

(76) Inventors: John J. Wuu, Fort Collins, CO (US); Donald R. Weiss, Fort Collins, CO (US); Matthew Ryan Unangst, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/653,020

(22) Filed: Aug. 30, 2003

(51) Int. Cl. G06F 11/00

(52) U.S. Cl. 714/42

(57) ABSTRACT

A computer system is disclosed that includes a memory, a memory defect map, and a shift encoder. The memory includes a plurality of bits and a plurality of input/output ports for accessing the plurality of bits. The memory defect map specifies positions of defective ones of the plurality of bits. The shift encoder encodes positions of defective ones of the plurality of bits in a shift encoding. The shift encoding includes a shift redundancy record representing positions of transitions between functional bits and defective bits in the memory, and a hints record representing numbers of bits in sets of consecutive defective bits in the memory.

### BACKGROUND

Integrated circuits are becoming increasingly small and densely packed. It is now possible, for example, to manufacture individual digital memory cells having an area of less than one square micron, and to pack hundreds of millions of transistors on a memory chip that is smaller than a dime. Due to uncontrollable variations in the manufacturing process, it is not possible to manufacture such memory chips perfectly. Any particular memory chip may include any number and variety of defects. For example, one or more memory cells on a chip may be defective and therefore be unable to store data reliably.

For a memory chip to be usable, however, the chip must be functionally indistinguishable from a chip having no defects. Because it is not possible to manufacture an actual defect-free chip, various techniques have been developed for automatically repairing defective chips so that they can provide the same functionality as a defect-free chip. Although it may not be possible to repair all defects in all chips, the ability to make even some chips usable by repairing them may increase the production yield of a particular batch of chips, thereby increasing the efficiency of the manufacturing process.

One technique that has been employed to repair chips is to include redundant circuit elements in the chips. Such redundant elements may be substituted for key circuit elements that prove to be defective. During testing of a chip, the defective portion of the circuit may be identified and the redundant circuit element, if one exists, may be activated by opening an associated fuse or similar mechanism. The redundant circuit element thereafter substitutes for and effectively replaces the original defective circuit element, thereby repairing the chip and making it usable. Redundancy is especially suited for repetitive circuits having a large number of repeating elements arranged in some form of array, such that a redundant circuit element can replace a single defective circuit element in a collection of circuit elements.

Memory chips are one example of such repetitive circuits. The memory in a memory chip is arranged in rows and columns. The redundant circuit element in such a chip may, for example, be a single memory cell, a row or collection of rows of memory cells, or a column or collection of columns of memory cells. If, for example, one cell in a given column is defective, the cell may be classified as defective. The defective cell, the column (or row) containing it, or the collection of columns (or rows) containing the defective cell may effectively be replaced by a redundant cell, row, column, or collection of rows or columns. In this way the chip may be made fully operational. Such repair makes it possible to use the memory chip reliably, thereby increasing the production yield by avoiding the need to discard the memory chip.

One technique that has been employed in memory repair is to generate a “shift redundancy pattern” that encodes mappings between memory input/output ports and functional bits in memory. Such a shift redundancy pattern may be used to control switching circuitry to connect input/output ports to the corresponding bits in memory, thereby effectively bypassing any defective bits.

Referring FIG. 1, for example, a diagram is shown illustrating an example memory 100 including eight bits 102a-h, including six main bits 102a-f and two spare (redundant) bits 102g-h. For ease of illustration and explanation, the bits 102a-h are shown simply as boxes. Empty boxes represent functional bits, while crossed boxes represent defective bits. The example memory 100 shown in FIG. 1 includes six functional bits (bits 102a-b, 102d-e, and 102g-h) and two defective bits (bits 102c and 102f). The data stored in bits 102a-h may be accessed through input/output ports 104a-f, referred to herein as IOs.

Well-known techniques may be used to test the memory 100 and thereby to determine that bits 102c and 102f are defective. Appropriate circuitry may then be employed to “shift” bits 102d-e by one position to the left, and to “shift” bits 102g-h by two positions to the left, so that the functional bits 102a-b, 102d-e, and 102g-h may be accessed through consecutive input/output ports 104a-f, and so that the defective bits 102c and 102f are rendered inaccessible. A set of mappings 106a-f is shown between each of the functional bits (bits 102a-b, 102d-e, and 102g-h) and corresponding ones of the IOs 104a-f. The mappings 106a-f are typically implemented using a set of multiplexers and/or other switching circuitry.

Once the mappings 106a-f are chosen, they may be encoded in a shift redundancy pattern. Such a pattern indicates the number of bit positions to shift each bit in a memory (such as memory 100) to effectively repair the memory. For example, a prior art shift redundancy pattern 108 is shown in FIG. 1. The shift redundancy pattern 108 includes six elements 108a-f, each of which corresponds to a particular one of the IOs 104a-f. For each of the IOs 104a-f, the corresponding element of the shift redundancy pattern 108 specifies a corresponding one of the bits 102a-f using an offset, referred to herein as a “shift value.” For example, assume that the IOs 104a-f have indices 0-5, respectively, and that the bits 102a-h have indices 0-7, respectively, as shown in FIG. 1. If srp(i) is the value of the shift redundancy pattern 108 at position i, then the IO at position i maps to the bit at position i+srp(i). In this way the shift values specified by the shift redundancy pattern may be applied to identify the bits to which each of the IOs 104a-f is mapped.

Consider, for example, the case in which i=0. In this case, srp(i)=0 (because the value of shift redundancy pattern element 108a is zero). Therefore, IO 104a maps to the bit at position 0+0, namely bit 102a. Now consider the case in which i=2. In this case, srp(i)=1, because the value of shift redundancy pattern element 108c is one. Therefore, IO 104c maps to the bit at position 2+1, namely bit 102d. Similarly, IO 104e (at position 4) maps to bit 102g (at position 6), because the value of shift redundancy pattern element 104e is 2, and 4+2=6. Because the pattern 108 directly encodes a shift value for each of the IOs 104a-f, the pattern 108 is said herein to be encoded using a “direct encoding scheme.”

The shift redundancy pattern 108 may then be embodied in a fuse block by blowing fuses in a pattern corresponding to the shift redundancy pattern 108. Thereafter, when the computer system containing the memory 100 is started up, the pattern 108 may be transmitted into a set of volatile memory elements, such as latches. The pattern 108 typically is shifted serially (i.e., one bit at a time) into the set of volatile memory elements. Once the shift redundancy pattern 108 is stored in the volatile memory elements it may be used to establish the mappings 106a-f and thereby effectively repair the memory 100.

This and other shift redundancy pattern generation schemes typically produce shift redundancy patterns that are proportional in size to the maximum permissible number of consecutive defective bits. Increasing the size of the shift redundancy pattern, however, typically increases the amount of circuitry required to store the pattern and increases the amount of time required to transmit the pattern to the circuitry that performs memory repair. Some shift redundancy pattern encoding schemes are capable of encoding any number of defective bits using a shift redundancy pattern having a fixed size, with the limitation that the shift redundancy pattern cannot encode a memory containing two or more consecutive defective bits.

It is desirable for shift redundancy patterns to be stored and accessed efficiently. It is also desirable for shift redundancy patterns to be capable of encoding multiple consecutive defective bits in digital memories.

### SUMMARY

In one aspect of the present invention, a computer-implemented method is provided for use in a computer system including a memory. The memory includes a plurality of bits at a plurality of positions. The method includes steps of: (A) identifying the position of a bit in a set of n consecutive defective bits in the memory; (B) generating an entry in a shift redundancy record indicating that the bit identified in step (A) is defective; and (C) generating a hint record indicating the number n of bits in the set of consecutive defective bits.

The number n may have any value, such as 1 or 2. Steps (A)-(C) may be repeated for a plurality of sets of consecutive bits in the memory. The shift redundancy record entry may be a single-bit entry, and the hint record may be a single-bit record. The hint record may represent the value n−1. The memory may include a plurality of input/output ports for accessing the plurality of bits, and the method may further include a step of: (D) controlling switching circuitry to disconnect the set of n consecutive defective bits from the input/output ports.

In another aspect of the present invention, a computer-implemented method is provided for use in a computer system including a memory. The memory includes a plurality of bits at a plurality of positions. Let b[i] refer to the bit at position i in the plurality of bits. The method includes steps of: (A) selecting a first value for a current shift redundancy record variable, wherein the current shift redundancy record value may be toggled between the first value and a second value; (B) for each of a plurality of consecutive values of i, performing steps of: (1) if bit b[i] is defective and bit b[i-1] is functional, performing steps of: (a) toggling the value of the current shift redundancy record variable; (b) identifying a set of n consecutive defective bits including bit b[i]; (c) storing a hint value in a hints record entry corresponding to bit b[i], the hint value indicating the number n; and (2) storing the current shift redundancy record value in a shift redundancy record element corresponding to bit b[i].

In another aspect of the present invention, a computer system is provided that includes: a memory including a plurality of bits and a plurality of input/output ports for accessing the plurality of bits; a memory defect map specifying positions of defective ones of the plurality of bits; and a shift encoder for encoding positions of defective ones of the plurality of bits in a shift encoding. The shift encoder includes: a shift redundancy record representing positions of transitions between functional bits and defective bits in the memory; and a hints record representing numbers of bits in sets of consecutive defective bits in the memory.

The shift redundancy record may include a plurality of shift redundancy record elements corresponding to the plurality of input/output ports. The number of bits in the hints record may be equal to H, and the value of H may be given by the following equation:

$$H = {\sum }_{j = 0}^{N - 2} ceil ( {log}_{2} ( N - j ) ) ,$$

where N is a maximum permitted number of consecutive defective bits in the memory, and wherein the ceil( ) function rounds up its single argument to the closest integer.

In another aspect of the present invention, a computer-implemented method is provided for use in a computer system including a memory, the memory including a plurality of bits and a plurality of input/output ports for accessing the plurality of bits. The method includes steps of: (A) receiving a shift encoding that encodes positions of defective ones of the plurality of bits, the shift encoding comprising a shift redundancy record that encodes transitions between functional bits and defective bits in the memory, and a hints record that encodes numbers of bits in sets of consecutive defective bits in the memory; and (B) generating, based on the shift encoding, a plurality of shift values that specify mappings between the plurality of input/output ports and corresponding ones of the plurality of bits.

The plurality of bits may have a plurality of consecutive positions within the memory, wherein b[i] refers to the bit at position i in the memory. The hints record may include at least one hints record element. Step (B) may include steps of: (1) identifying a position i for which bit b[i] is defective and bit b[i-1] is functional; (2) identifying a hints record element in the hints record that corresponds to bit b[i]; and (3) generating a select one of the plurality of shift values based on the hints record element identified in step (B)(2).

The hints record element identified in step (B)(2) may have a hint value. Step (B)(3) may include a step of assigning the hint value plus one to the select one of the plurality of shift values. Step (B) may further include a step of identifying a previous shift value, and step (B)(3) may include a step of assigning the previous shift value plus the hint value plus one to the select one of the plurality of shift values.

The shift redundancy record may include a plurality of shift redundancy values. Let SRP[i] refer to a shift redundancy value having index i in the plurality of shift redundancy values. Step (B) may include steps of: (1) selecting an initial shift value for a default shift variable; (2) selecting as a current hints record element an initial hints record element having an initial hint value; (3) for each of a plurality of consecutive values of i, performing steps of: (a) if SRP[i] is not equal to SRP[i-1], performing steps of: (i) adding one plus a value of the current hints record element to the value of the default shift variable to produce a new value for the default shift variable; and (ii) selecting as the current hints record element a next hints record element having a next hint value; and (b) generating a shift value in the plurality of shift values that is equal to the value of the default shift variable.

In another aspect of the present invention, a computer system is provided that includes: a memory comprising a plurality of bits and a plurality of input/output ports for accessing the plurality of bits, wherein IO[i] refers to an input/output port at position i; a plurality of stored shift redundancy record signals representing shift values for the plurality of I/O ports, wherein SRP[i] refers to a shift redundancy record signal for input/output port IO[i]; a stored hints record signal representing the number of bits in a set of consecutive defective bits in the memory; a first multiplexer comprising a first data input receiving the stored hints record signal, a second data input receiving a signal R0[i-1], a selection input receiving signal SRP[i], and an output providing a signal R1[i]; and a second multiplexer comprising a first data input receiving a signal having a predetermined voltage level, a second data input receiving signal R0[i-1], a selection input receiving SRP[i], and an output providing a signal R0[i].

The computer system may further include: a first inverter comprising an input receiving signal R0[i] and an output providing a first inverted signal; a second inverter comprising an input receiving signal R1[i] and an output providing a second inverted signal; a first NAND gate comprising a first input coupled to the output of the first inverter, a second input coupled to the output of the second inverter, and an output providing a first NAND signal; a second NAND gate comprising a first input receiving signal R0[i], a second input coupled to the output of the second inverter, and an output providing a second NAND signal; a third inverter coupled to the output of the first NAND gate and an output providing a signal SHIFT0; a fourth inverter coupled to the output of the second NAND gate and an output providing a signal SHIFT1; and a fifth inverter coupled to the output of the third NAND gate and an output providing a signal SHIFT2.

Other features and advantages of various aspects and embodiments of the present invention will become apparent from the following description and from the claims.

### BRIEF DESCRIPTION OF THE DRAWINGS

FIG. 1 is a diagram illustrating prior art techniques for repairing a memory including two non-consecutive defective bits;

FIG. 2 is a diagram illustrating prior art techniques for repairing a memory including two consecutive defective bits;

FIG. 3 is a diagram illustrating a shift redundancy pattern and corresponding hints table that encode mappings between functional memory bits and IOs according to one embodiment of the present invention;

FIG. 4 is a diagram illustrating a shift redundancy pattern and corresponding hints table that encode mappings between functional memory bits and IOs according to another embodiment of the present invention;

FIG. 5 is a dataflow diagram of a system for repairing a digital memory according to one embodiment of the present invention;

FIGS. 6A-6B are flowcharts of a method that is performed by the system of FIG. 5 to produce a shift encoding according to one embodiment of the present invention;

FIG. 7 is a flowchart of a method for decoding the shift encoding produced by the method of FIGS. 6A-6B to produce a plurality of shift value signals according to one embodiment of the present invention;

FIG. 8 is a schematic diagram of circuitry for decoding a shift redundancy pattern and a corresponding hints table into an intermediate shift value signal according to one embodiment of the present invention;

FIG. 9 is a flowchart of a method that is performed by the system of FIG. 8 according to another embodiment of the present invention; and

FIG. 10 is a schematic diagram of circuitry for translating the intermediate shift value signal generated by the circuitry of FIG. 8 into a final shift value signal; and

FIG. 11 is a flowchart of a method that is performed by the circuitry of FIG. 10 according to one embodiment of the present invention.

### DETAILED DESCRIPTION

Techniques are disclosed for encoding mappings between functional (i.e., non-defective) bits in a digital memory and input/output ports for accessing the functional bits. Such mappings may be encoded in a shift encoding that includes a shift redundancy pattern and a hints table. The shift redundancy pattern may indicate positions of transitions from functional bits to defective bits in the digital memory. The hints table may indicate the number of defective bits in each set of consecutive defective bits in the digital memory. The combination of the shift redundancy pattern and hints table may be used to electrically connect the memory input/output ports to corresponding functional bits in the digital memory, thereby bypassing the defective bits and effectively repairing the memory. The shift encoding may be stored using a relatively small number of circuit elements and accessed relatively quickly to perform memory repair.

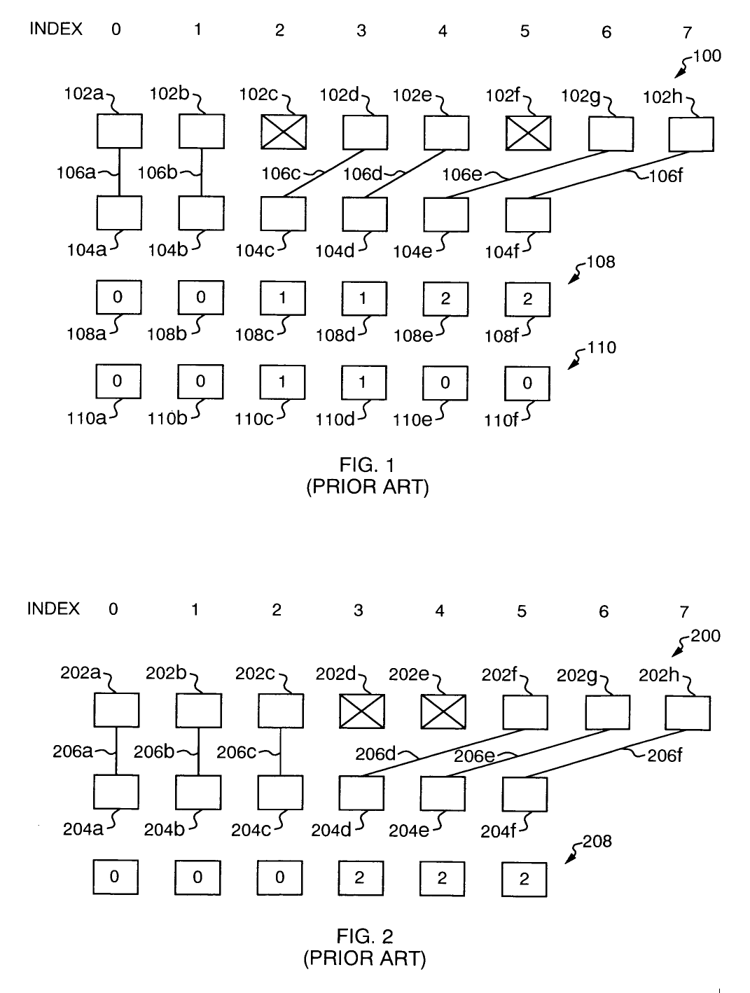

Before describing embodiments of the present invention in more detail, features of certain prior art systems for performing memory repair will be described in more detail. For example, one limitation of the direct encoding scheme used to generate the shift redundancy pattern 108 shown in FIG. 1 is that two bits are required to represent each element in the pattern 108 because each element may have a value of 0, 1, or 2. As the maximum number of positions by which a bit may be shifted increases, so does the number of bits required to represent each element in the pattern 108. In particular, if N is the maximum number of positions by which a bit may be shifted, the number of bits required to represent each element in the pattern 108 is equal to log₂ N.

Increasing the number of bits required to encode a shift redundancy pattern can be problematic because a larger pattern typically requires a larger number of serial shift elements (e.g., latches) to implement, thereby increasing the size and cost of the required circuitry, and because it takes more time to transmit a longer pattern during system startup and therefore to perform memory repair.

One technique that has been used to reduce the number of bits required to encode a shift redundancy pattern is described in Barth, J., et al., “A 300 MHz Multi-Banked eDRAM Macro Featuring GND Sense, Bit-Line Twisting and Direct Reference Cell Write,” 2002 IEEE ISSCC Digest of Technical Papers, vol. 45, pp.156-157, February 2002. According to the scheme described therein (referred to herein as “the Barth scheme”), a single bit may be used to encode each element in a shift redundancy pattern, provided that no bit needs to be shifted by more than one position (i.e., provided that the memory does not include two or more defective bits in consecutive bit positions).

According to the Barth scheme, the bit value in the shift redundancy pattern is toggled each time a defective memory bit is encountered. For example, referring again to FIG. 1, a shift redundancy pattern 110 encoded in accordance with the Barth scheme is shown. Consider the generation of the pattern 110 moving from left to right in FIG. 1. An initial value of zero is assigned to elements of the pattern 110 by default. The first two elements 110a-b of the pattern 110 have the default value of zero because both of the bits 102a-b are functional and therefore do not need to be shifted. Bit 102c, however, is defective. As a result, the current value of the shift redundancy pattern 110 is toggled, resulting in a shift value of one. This value is assigned to elements 110c-d, thereby specifying mappings 106c-d between IOs 104c-d and bits 102d-e, respectively.

The next defective bit 102f is then encountered. The current value of the shift redundancy pattern 110 is again toggled, resulting in a pattern value of zero, which is assigned to the remaining two elements 110e-f in the shift redundancy pattern 110. The pattern 110 thereby produced is invertible, so that it may be read to determine how many bit positions to shift each of the bits 102a-h. One advantage of the Barth scheme in comparison with the direct encoding scheme described above is that shift redundancy patterns produced according to the Barth scheme use only a single bit per pattern element, thereby reducing the total size of the shift redundancy pattern.

Referring to FIG. 2, a memory 200 is shown which includes bits 202a-h. Bits 202a-c and 202f-h are functional, while bits 202d-e are defective. Although the shift redundancy pattern 108, encoded according to the direct encoding scheme described above, is capable of producing a shift redundancy pattern 208 that unambiguously encodes mappings 206a-f between bits 202a-h and IOs 204a-f, the Barth scheme described above cannot produce an unambiguous encoding of the mappings 206a-f because the memory 200 includes two consecutive defective bits 202d-e. For example, a pattern such as 000111 produced according to the Barth scheme would fail to indicate that bits 202f-h should each be shifted by two, rather than one, position.

As mentioned above, memory chip manufacturers desire as high a chip yield as possible to minimize the number of chips that must be discarded and therefore not sold. If a shift redundancy scheme is used that is only capable of repairing memories having non-consecutive defective bits, any memories having two or more defective bits will be incapable of being repaired.

The ability to repair memory chips having two or more consecutive defective bits would enable such chips to become usable and thereby advantageously increase the production yield of a particular batch of chips. In addition, it is desirable for such a pattern to encode memory defects relatively efficiently, to reduce the amount of circuitry required to implement the pattern, and to decrease the amount of time required to shift the pattern through serial shift elements.

Embodiments of the present invention will first be described by reference to examples of encodings that may be produced by embodiments of the present invention. After describing such examples, techniques for producing such encodings will be described. Then, techniques for decoding such encodings will be described. Finally, circuitry that may be used to implement embodiments of the present invention will be described.

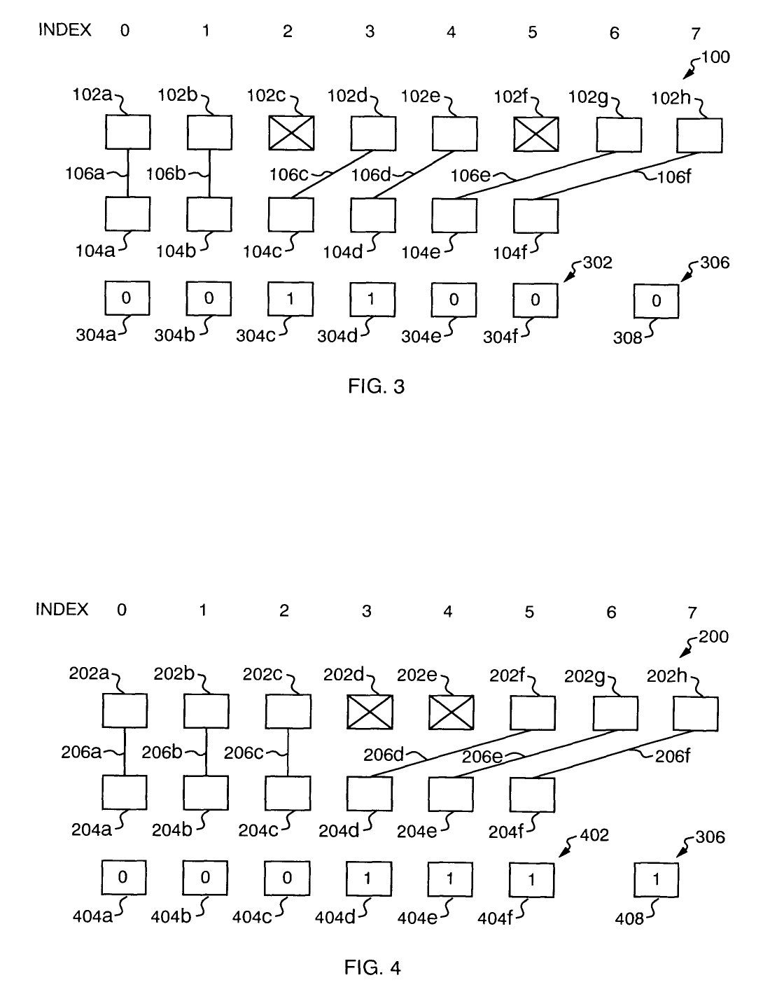

Referring to FIG. 3, a diagram is shown illustrating the same memory 100, IOs 104a-f, and memory-IO mappings 106a-f as FIG. 1. FIG. 3 also shows a shift redundancy pattern 302 and a corresponding hints table 306 generated according to one embodiment of the present invention. If none of the bits 102a-f is defective, each of the IOs 104a-f maps to the bit directly above it in FIG. 3. For example, if bit 102a is not defective, then IO 104a maps to bit 102a. Bit 102a is therefore referred to herein as the “default bit” for IO 104a, bit 102b is referred to herein as the default bit for IO 104b, and so on.

The pattern 302 and hints table 306 may encode the mappings 106a-f as follows. Pattern 302 includes six one-bit elements 304a-f corresponding to IOs 104a-f, respectively. In the particular example shown in FIG. 3, the hints table 306 includes a single one-bit element 308. As will be described in more detail below, however, the hints table 306 may include multiple elements, each of which may include one or more bits.

Returning to the shift redundancy pattern 302, the initial zero values in pattern elements 304a-b indicate that IOs 304a-b are to be mapped to “non-shifted” bits 102a-b, respectively, in memory 100. The value of pattern element 304c, however, is equal to one. This value transition (from 0 in element 304b to 1 in adjacent element 304c) indicates that IO 104c is to be mapped to a bit in memory 100 that is shifted by at least one, but possibly more than one, bit position with respect to default bit 102c of IO 304c. A shift of one bit position is therefore referred to herein as the “default shift” indicated by the transition in the pattern 302 from element 304b to adjacent element 304c. The value of the single element 308 in the hints table 306 indicates how many bit positions to add to the default shift to obtain the total number of positions to shift to identify the bit mapped to IO 304c. In the example illustrated in FIG. 3, the value of hints table element 308 is zero, so the total number of positions to shift is equal to 1+0, which is equal to 1. IO 104c therefore maps to bit 102d (which is shifted from the default bit 102c by one bit position), as indicated by mapping 106c.

The value of pattern element 304d does not differ from that of pattern element 304c, so IO 104d also maps to a bit (namely bit 102e) that is shifted by one position from IO 104d's default bit 102d, as indicated by mapping 106d.

The value of pattern element 304e, however, differs from that of pattern element 304d. This transition in value indicates that IO 104e is to be mapped to a bit in memory 100 that is shifted by at least two bit positions with respect to default bit 102e. If there were additional elements in the hints table 306, the next element of the hints table 306 would indicate how many bit positions to add to the default shift to obtain the total number of positions to shift. Because the hints table 306 does not include any additional elements, however, IO 104e is mapped to a bit (namely bit 104g) that is shifted by two bit positions (i.e., the default shift value) with respect to bit 104e, as indicated by mapping 106e. Similarly, IO 104f is mapped to bit 102h, which is shifted by two bit positions with respect to IO 104f's default bit 102f, because there is no value transition from pattern element 304e to adjacent pattern element 304f. This result is indicated by mapping 106f.

It has thus been demonstrated that the combination of shift redundancy pattern 302 and hints table 306 accurately encode the memory-IO mappings 106a-f and may be decoded to identify the mappings 106a-f.

Referring to FIG. 4, a diagram is shown illustrating the same memory 200, IOs 204a-f, and memory-IO mappings 206a-f as FIG. 2. FIG. 4 also shows a shift redundancy pattern 402 and a corresponding hints table 406 generated according to one embodiment of the present invention.

The pattern 402 and hints table 406 encode the mappings 106a-f as follows. Pattern 402 includes six one-bit elements 404a-f corresponding to IOs 404a-f, respectively. In the particular example shown in FIG. 4, the hints table 406 includes a single one-bit element 408.

Returning to the shift redundancy pattern 402, the initial zero values in pattern elements 404a-c indicate that IOs 204a-c are to be mapped to their respective default bits 202a-c, in memory 200.

The value of pattern element 404d, however, is equal to one. This value transition (from 0 to 1) indicates that IO 204d is to be mapped to a bit in memory 200 that is shifted by at least one, but possibly more than one, bit position with respect to IO 204d's default bit 202d. As described above, the value of the single element 408 in the hints table 406 indicates how many bit positions to add to the default shift to obtain the total number of positions to shift to identify the bit to which IO 204d is mapped. In the example illustrated in FIG. 4, the value of element 408 is one, so the total number of positions to shift is equal to 1+1, which is equal to 2. IO 204d therefore maps to bit 202f (which is shifted from the default bit 202d by two bit positions), as indicated by mapping 206d.

The values of pattern elements 404e-f do not differ from that of pattern element 404d, so IOs 204e-f also map to bits (namely bits 102g-h, respectively) that are shifted by two positions from IO 204e-f's default bits 202e-f, as indicated by mappings 206e-f.

It has thus been demonstrated that the combination of shift redundancy pattern 402 and hints table 406 accurately encode the memory-IO mappings 206a-f and may be decoded to identify the mappings 206a-f. Note that the pattern 402 and hints table 406 encode the mappings 206a-f using a total of only 7 bits (one bit for each of elements 404a-f and 408). In contrast, the shift redundancy pattern 208 produced by the “direct encoding” method in FIG. 2 requires a total of 12 bits (2 for each of the six IOs 204a-f), while the Barth scheme is not capable of encoding the mappings 206a-f.

In the particular examples shown in FIGS. 3 and 4, there are at most two consecutive defective bits in memory. Embodiments of the present invention, however, are not limited to use in conjunction with memories having at most two consecutive defective bits. Rather, embodiments of the present invention may be used in conjunction with memories having any number of consecutive defective bits.

Even more generally, embodiments of the present invention may be used in conjunction with memories having any total number of defective bits arranged in any pattern. For example, techniques disclosed herein may be used in conjunction with a memory having a sequence of multiple consecutive defective bits, followed by some number of functional bits, followed by a sequence of multiple consecutive defective bits, followed by some number of functional bits, followed by a single defective bit.

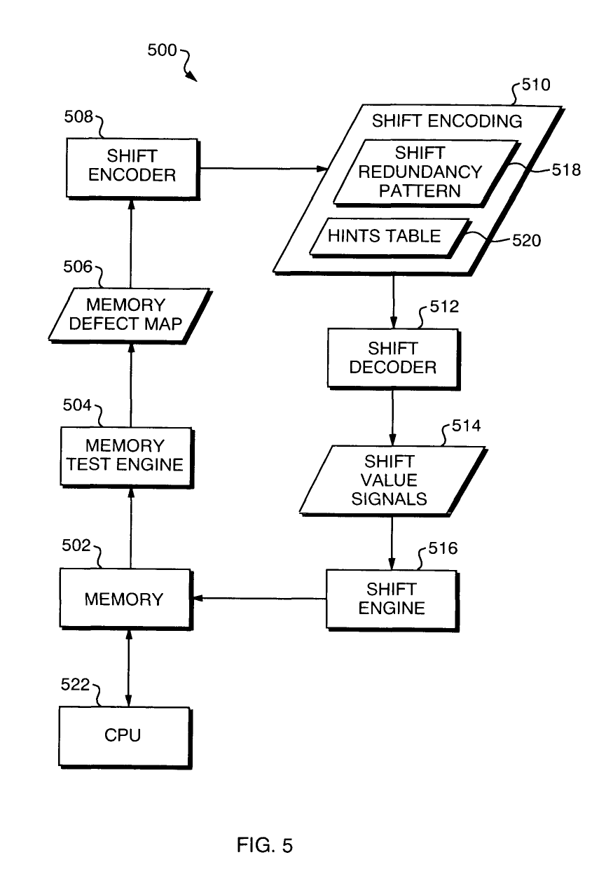

Examples of techniques for encoding the positions of defective bits using a shift redundancy pattern and a hints table in accordance with embodiments of the present invention will now be described. Referring to FIG. 5, a dataflow diagram is shown of a system 500 for repairing a memory 502 according to one embodiment of the present invention. In particular, the system 500 includes a memory test engine 504. The memory test engine 504 tests the individual bits in the memory 502 to determine whether each bit is functional or defective. Techniques for testing digital memories are well-known to those of ordinary skill in the art.

The memory test engine 504 produces a memory defect map 506 as a result of testing the memory 502. The memory defect map 506 indicates which bits in the memory 502 are functional and which bits in the memory 502 are defective. The memory defect map 506 may represent this information in any of a variety of ways. For example, the memory defect map 506 may include a list of addresses and/or bit positions of each of the defective and/or functional bits, or a bit-by-bit map which specifies whether each bit in the memory 502 is functional or defective. The memory defect map 506 need not, however, be a “map” in the sense of including elements that have a one-to-one correspondence with individual bits in the memory 502.

The system 500 also includes a shift encoder 508. The shift encoder 508 receives memory defect map 506 as input and produces as output a shift encoding 510 that encodes positions of defective bits in the memory 502. The shift encoder 508 may, for example, be implemented in analog and/or digital circuitry for performing the functions disclosed herein.

The encoding 510 produced by the shift encoder 508 includes both a shift redundancy pattern 518 and a hints table 520. The shift redundancy patterns 302 and 402 shown in FIGS. 3 and 4, respectively, are examples of the shift redundancy pattern 518. Similarly, the hint tables 306 and 406 shown in FIGS. 3 and 4, respectively, are examples of the hints table 520.

The shift encoder 508 may, for example, encode the shift redundancy pattern 518 and hints table 520 as follows. The system 500 may include a fuse block (not shown) including a plurality of fuse bits corresponding to locations in the memory 502. The shift encoder 508 may burn fuse bits corresponding to the locations of failing bits in the memory 502, as specified by the memory defect map 506. The shift encoder 508 may also include a static encoding circuit that generates the shift redundancy pattern 518 and hints table based on the state of the fuse bits in the fuse block.

The system 500 also includes a shift decoder 512. The shift decoder 512 receives the shift encoding 510 as an input and produces a plurality of shift value signals 514 as an output. The shift value signals 514 specify mappings between memory input/output ports and functional bits in the memory 502. The shift value signals 514 may, for example, specify such mappings using shift values which specify positional offsets to apply to each bit in memory to identify the input/output port to which the bit is to be electrically connected. Each of the shift value signals 514 may, for example, represent a shift value to apply to a corresponding IO in the memory 502 to map the IO to a corresponding functional bit in the memory 502.

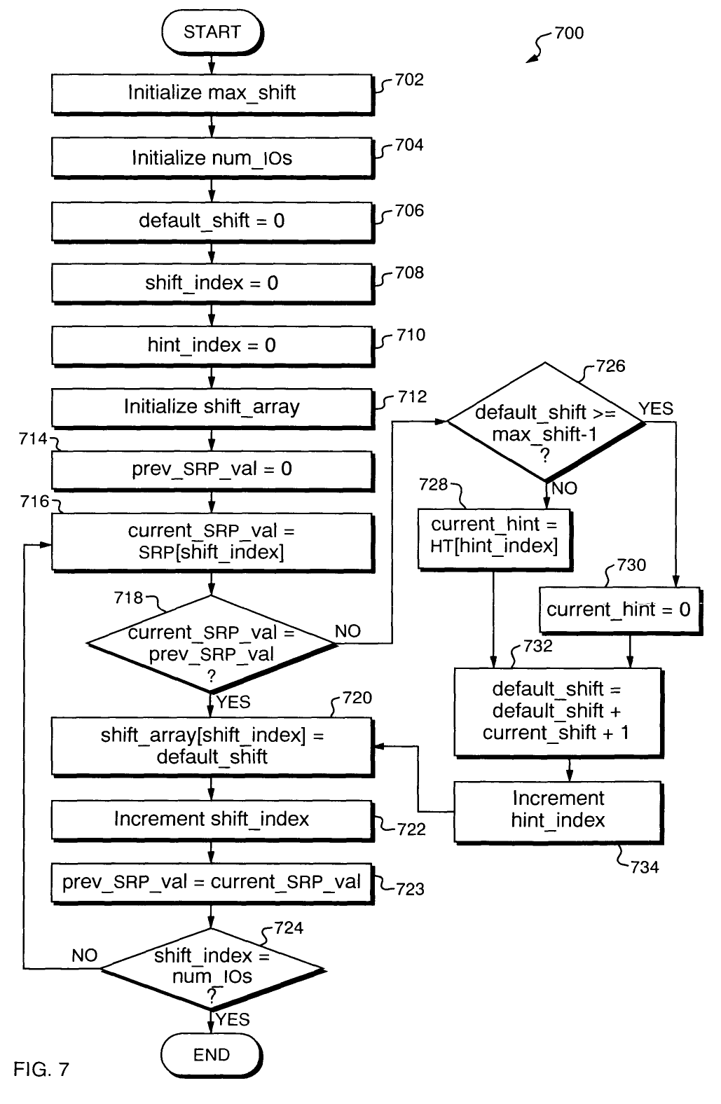

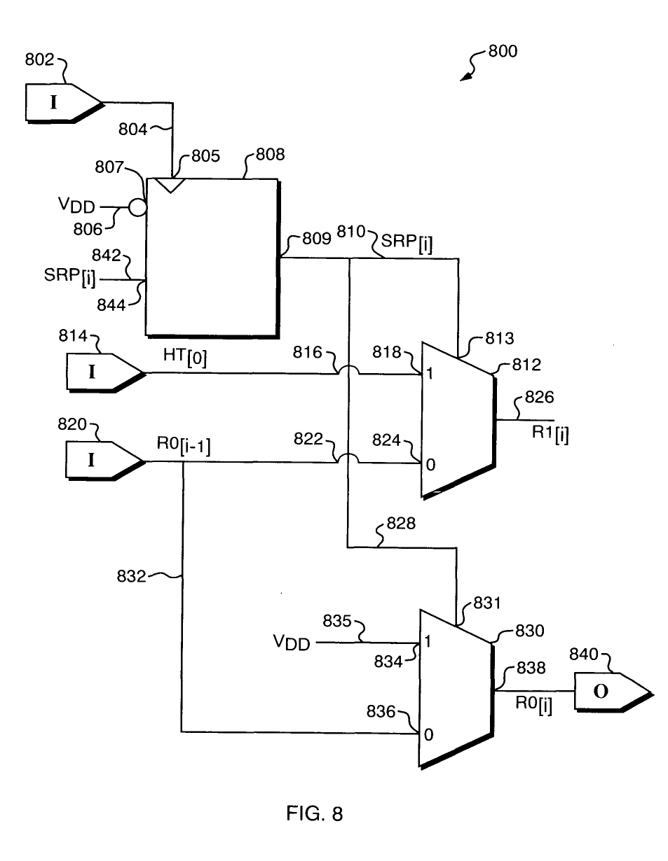

The shift decoder 512 may, for example, transfer the shift redundancy pattern 518 and hints table 520 into a plurality of latches at system power-up, and then serially shift the shift redundancy pattern 518 and hints table 520 to the memory 502, where they are again stored in latches. Operation of the shift decoder 512 according to one embodiment of the present invention will be described in more detail below with respect to FIGS. 7-8.

The system 500 also includes a shift engine 516 that receives the shift value signals 514 and repairs the memory 502 in response. In particular, the shift engine 516 applies the shift values specified by the shift value signals 514 to the input/output ports in the memory 502 to electrically disconnect the input/output ports from the defective bits in the memory 502 and to electrically connect the input/output ports to corresponding functional bits in the memory 502. The shift engine 516 may be implemented, for example, using switching circuitry such as a series of multiplexers, as described in more detail in U.S. patent application Ser. No. 10/316,651, entitled “Repair Techniques for Memory with Multiple Redundancy,” filed on Dec. 11, 2002, hereby incorporated by reference herein.

The system 500 also includes a CPU 522 that may transparently access the functional bits in the memory 502 once the memory 502 has been repaired by the shift engine 516.

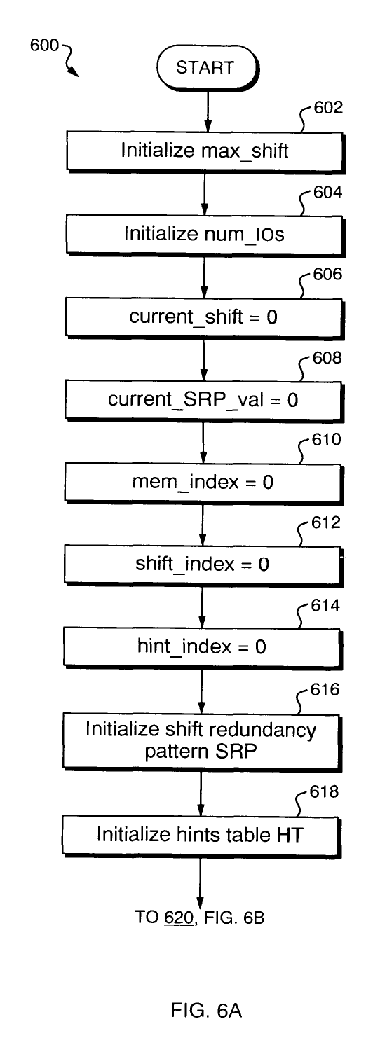

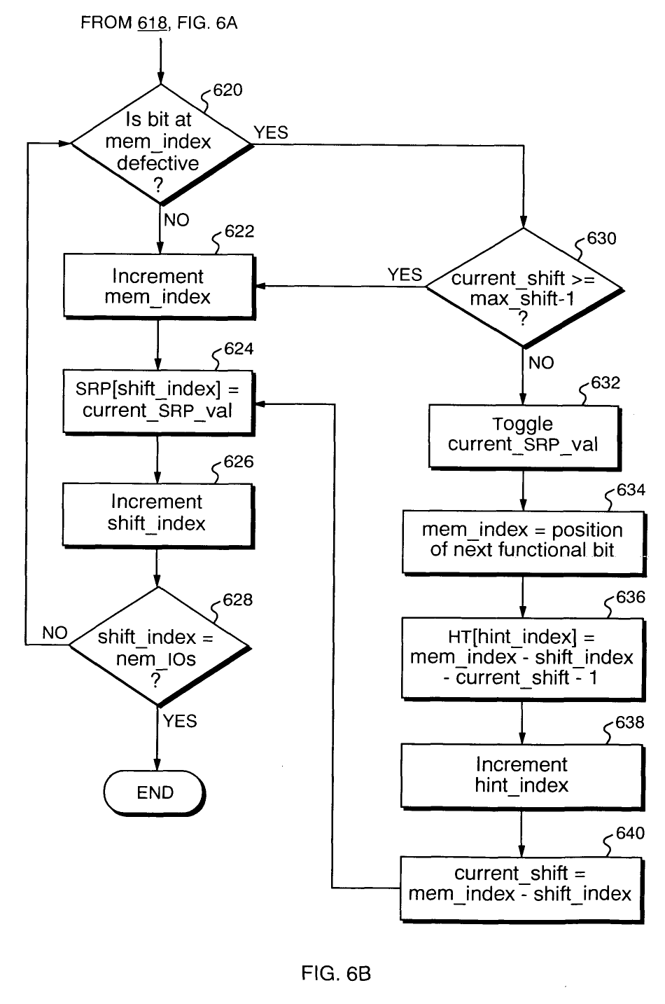

Referring to FIGS. 6A-6B, flowcharts are shown of a method 600 that is used by the system 500 of FIG. 5 to produce the shift encoding 510 according to one embodiment of the present invention. The method 600 begins by initializing variables that are used by the method 600. For example, the method 600 initializes the value of a variable max_shift to a predetermined value (step 602). The value of max_shift indicates the maximum number of contiguous defective memory bits that may be encoded by the encoding 510. Although the value of max_shift is equal to 2 in the examples illustrated by FIGS. 3 and 4, max_shift may have any value.

The method 600 initializes the value of a variable num_IOs, which represents the number of IOs for which shift values are encoded by the encoding 510 (step 604). In the examples illustrated in FIGS. 3 and 4, the value of num_IOs is 6.

The values of variables current_shift, current_SRP_val, mem_index, shift_index, and hint_index are initialized to zero (steps 606-614). The functions performed by these variables will be described in more detail below. The shift redundancy pattern 518 is represented by a variable SRP, which is initialized in step 616. Similarly, the hints table 520 is represented by a variable HT, which is initialized in step 618. If the method 600 is implemented in software, steps 616 and 618 may, for example, include allocating arrays representing the shift redundancy pattern 518 and hints table 520 and storing initial values of zero in each element of said arrays. If the method 600 is implemented in hardware, steps 616 and 618 may, for example, include shifting predetermined voltage levels into latches or other memory elements that store values representing the shift redundancy pattern 518 and hints table 520. In the description below, the notation SRP[i] refers to the element of the shift redundancy pattern 518 at index i, and HT[i] refers to the element of the hints table 520 at index i.

The method 600 determines whether the memory bit at the position indicated by the variable mem_index is defective (step 620). The method 600 may, for example, make this determination by reference to the memory defect map 506 and the value of mem_index. If the memory bit at position mem_index is not defective, the method 600 increments the value of mem_index (step 622), stores the value of the variable current_SRP_val in the shift redundancy pattern element at index shift_index (step 624), and increments the value of shift_index (step 626). The method 600 determines whether the new value of shift_index is equal to the value of num_IOs (step 628). If it is, the method 600 terminates. Otherwise, the method 600 returns to step 620.

Note that if the memory defect map 506 indicates that all of the memory bits are functional (i.e., non-defective), the method 600 will execute a loop over steps 620-628 and thereby store the value zero (the default value of current_SRP_val) in every element of the shift redundancy pattern 518. Furthermore, all of the elements of the hints table 520 will have zero values upon the completion of the method 600, as a result of the initialization performed in step 618. These are the expected results for a memory with no defects.

If, however, the method 600 encounters a defective memory bit at position mem_index in step 620, then a transition from a functional bit to an adjacent defective bit has been encountered. This is referred to herein as a functional-defective transition.

In step 630 the method 600 determines whether the value of current_shift is greater than or equal to the value of max_shift−1. As described in more detail below, a hint table entry is not required for the final set of consecutive defective bits in the memory 502 if the final set includes only one bit. If the method 600 determines in step 630 that current_shift is greater than or equal to max_shift−1, the method 600 proceeds to step 622 without storing any additional data in the hints table 520.

If current_shift is less than max_shift−1, the method 600 toggles the value of current_SRP_val (step 632). For example, current_SRP_val may be a one-bit value, in which case current_SRP_val may be toggled by changing its value from 0 to 1 or from 1 to 0. The value of current_SRP_val is the value to be stored in the shift redundancy pattern 518 at position shift_index.

The method 600 identifies the position of the next functional memory bit and assigns the identified position to mem_index (step 634). For example, referring again to FIG. 2, the next functional bit after defective bit 102c is bit 102d, and the next functional bit after defective bit 102f is bit 102g. Similarly, referring to FIG. 3, the next functional bit after defective bit 202d is bit 202f. The method 600 may identify the next functional bit with respect to a particular bit b by starting at the bit b and looking rightward in the memory (e.g., using the memory defect map 506) until a functional bit is found.

The method 600 stores the value (mem_index−shift_index−current_shift−1) at index hint index of the hints table 520 (step 636). As will be explained in more detail in the examples described below, the formula used in step 636 stores a value in the hints table 520 that may be added to the corresponding value in the shift redundancy pattern 518 to produce a shift value to apply to the IO at index shift_index.

The method 600 increments hint_index (step 638) and assigns the value mem_index−shift_index to the variable current_shift (step 640). The variable current_shift indicates the current shift value that the method 600 is storing in the shift redundancy pattern 518.

The method 600 proceeds to step 624 to store an appropriate value in the shift redundancy pattern 518 and to continue processing the memory defect map 506. Upon completion of the method 600, both the shift redundancy pattern 518 and the hints table 520 contain values that encode the memory defect map 506 using the scheme described above with respect to FIGS. 3 and 4.

Having described the encoding method 600 illustrated in FIGS. 6A-6B, application of the method 600 to the particular memories 300 and 400 will now be described to further explain the operation of the method 600. First consider application of the method 600 to the memory 300 shown in FIG. 3. The method 600 performs initialization in steps 602-618, as described above.

Now consider performance of step 620 when mem_index=0. The method 600 determines whether the memory bit at position mem_index (namely, bit 102a) is defective. The method 600 determines that bit 102a is not defective, and therefore proceeds to step 622, in which the value of mem_index is incremented to a value of 1. The method 600 stores the value of current_SRP_val (namely, zero) in element zero 304a of the shift redundancy pattern 518 (step 624). The method 600 increments shift_index to a value of 1 (step 626). Because shift_index is not equal to num_IOs (i.e., 6) (step 628), the method 600 returns to step 620.

The method 600 determines that bit 102b is not defective, and therefore increments mem_index to a value of 2 (step 622), stores the value of current_SRP_val (namely, zero) in element one 304b of the shift redundancy pattern 518 (step 624), increments shift_index to a value of 2 (step 626), and returns again to step 620.

Now that mem_index=2, the method 600 determines in step 620 that bit 102c is defective. The method 600 therefore proceeds to step 630. Assuming for purposes of the present example that max_shift=2, the method 600 determines in step 630 that current_shift is not greater than or equal to max_shift−1 and therefore proceeds to step 632. The method 600 toggles the value of current_SRP_val (step 632), as a result of which current_SRP_val=1.

The next functional bit after defective bit 102c is bit 102d, at position 3. The method 600 therefore assigns the value 3 to the variable mem_index in step 634.

When the method 600 executes step 636, mem_index=3, shift_index =2, and current_shift =0. Therefore, the value of the expression p−mem_index−current_shift−1 in step 636 is equal to 3−2−0−1=0. Recall that hint_index=0, as initialized in step 614. The method 600 in step 638 therefore assigns the value 0 to the element at index 0 in the hints table.

The method 600 increments hint_index to a value of 1 (step 638). The method 600 assigns the value of mem_index−shift_index=2−1=1 to current_shift (step 640), thereby indicating that the method 600 is currently shifting bits by one bit position.

The method 600 proceeds to step 624, in which the value of current_SRP_val (namely, 1) is assigned to element 304c of the shift redundancy pattern 518. The variable shift_index is incremented to a value of 3, and the method 600 returns to step 620.

Bit 102d is determined not to be defective in step 620. As a result, mem_index is incremented to a value of 4 (step 622), the value 1 is stored in element 304d of the shift redundancy pattern 518 (step 624), shift_index is incremented to a value of 4 (step 626), and the method 600 returns to step 620. Steps 620-626 are then performed similarly to store the value 1 in element 304e of the shift redundancy pattern 518 and to assign the value 5 to both mem_index and shift_index.

Bit 102f is determined to be defective in step 620. The value of current_shift is determined to be equal to max_shift−1 (step 630), so the method 600 proceeds to step 622 without storing any additional data in the hints table 520.

The variable mem_index is incremented to a value of 7 (step 622), and the value 0 is stored in element 304e of the shift redundancy pattern 518 (step 624). The variable shift_index is incremented to a value of 5 (step 626), and the method 600 returns to step 620. In steps 620-626 the value 0 is stored in element 304f of the shift redundancy pattern using techniques described above.

At this point, shift_index=6. As a result, shift_index is determined in step 628 to be equal to num_IOs, and the method 600 terminates. The discussion above demonstrates that the method 600 produces the encoding (i.e., shift redundancy pattern 302 and hints table 306) shown in FIG. 3 when provided with a memory defect map that specifies the locations of the defective bits 102c and 102f in the memory 100.

Application of the method 600 to the memory 200 shown in FIG. 4 will now be described briefly to demonstrate that the method 600 produces the encoding (i.e., shift redundancy pattern 402 and hints table 406) shown in FIG. 4 when provided with a memory defect map that specifies the locations of the consecutive defective bits 202d-e in the memory 200.

The method 600 performs initialization in steps 602-618, as described above. The method 600 then iterates over steps 620-628 to store zero values in elements 404a-c of shift redundancy pattern 402 in the manner described above.

When the method 600 encounters defective bit 202d, however, the method 600 identifies bit 202f(at position 5) as the next functional bit. The method 600 therefore assigns the value 5 to mem_index in step 634. At this point hint_index=0, shift_index=3, and current_shift =0. As a result, the value of the expression mem_index−shift_index−current_shift−1 is equal to 5−3−0−1, which is equal to 1. As a result, the value 1 is stored in element 408 of the hints table 406 in step 636, as shown in FIG. 4.

The remaining steps of the method 600 may be traced to verify that the method 600 produces the shift redundancy pattern 402 and hints table 406 shown in FIG. 4 when the method 600 is provided with a memory defect map that specifies the positions of the defective bits 202d-e in memory 200. The method 600 may be applied more generally to memories having any number of defective bits, including any number of contiguous defective bits, and any number of groups of contiguous defective bits.

Having described techniques for creating the encoding 510 of memory defect map 506, techniques will now be described for decoding the encoding 506 to produce the shift value signals 514.

Referring to FIG. 7, a flowchart is shown of a method 700 that is used by the system 700 of FIG. 7 to produce the shift value signals 514 according to one embodiment of the present invention. The method 700 begins by initializing variables that are used by the method 700. In particular, the method 700 initializes the variables max_shift, num_IOs, default_shift (which serves a purpose similar to that of current_shift in method 700), shift_index, and hint_index (steps 702-710) in the manner described above with respect to steps 602-618 of method 600 (FIG. 6). The method 700 also initializes a variable shift_array (step 712) that represents the shift values 514. The variable shift_array may, for example, be initialized as an array having the same number of elements as the number of IOs, in which each element may be initialized to a zero value.

The method 700 also initializes a variable prev_SRP_val to zero (step 714). The variable prev_SRP_val indicates the most recently-encountered value in the shift redundancy pattern 518. This variable is initialized to zero so that the first non-zero value that is encountered in the shift redundancy pattern 518 will be treated by the method 700 as indicating a functional-defective transition.

The method 700 obtains the value of the shift redundancy pattern 518 at index shift_index, and assigns this value to a variable current_SRP_val (step 716). The method 700 determines whether current_SRP_val is equal to the value of prev_SRP_val (step 718). If the two values are equal, then no functional-defective transition has been encountered, and the method 700 stores the value of default_shift in the shift array 514 at index shift_index (step 720). The method 700 increments the value of shift_index (step 722) and assigns the value of current_SRP_val to the variable prev_SRP_val (step 723). If the value of shift_index is not equal to the value of num_IOs (step 724), the method 700 returns to step 716.

If all of the elements in the shift redundancy pattern 518 are equal to zero, the method 700 will iterate over steps 716-724 and store the value zero in all of the shift value signals 514. This is the correct result, since such shift value signals 514 indicate that all of the IOs (e.g., IOs 104a-f) are to be mapped to their respective default bits.

If, however, the method 700 encounters a value transition in the shift redundancy pattern 518 at step 718 (e.g., a transition from 0 to 1 or from 1 to 0), the method 700 proceeds to step 726. As described above, when a value transition occurs in the shift redundancy pattern 518, the corresponding value in the hints table 520 may be used to identify a shift value to apply to the corresponding IO.

The method 700 determines whether the value of default_shift is greater than or equal to the value of max_shift−1 (step 726). As will be described in more detail below, a hint table entry is not required for the final set of consecutive defective bits in the shift redundancy pattern 518 if that set includes only one bit. As a result, if default_shift≧max_shift−1, the method 700 assigns a value of zero to the variable current_hint (step 730). Otherwise, the method 700 looks up the value stored in the hints table 520 at index hint_index, and stores the value in the variable current_hint (step 728).

The method 700 increases the value of the variable default_shift by the value of current_hint+1 (step 732). For example, if current_hint=0, then the value of default_shift is simply incremented. If current_hint=1, the value of default_shift is increased by 2; if current_hint=2, the value of default_shift is increased by 3, and so on. The method 700 increments the value of hint_index (step 734) and proceeds to step 720, in which the value of default_shift is stored in the shift array 514 at index shift_index, as described above. Steps 726-734 are performed each time the method 700 encounters a functional-defective transition in the shift redundancy pattern 518, thereby using the hints table 520 to ascertain the appropriate shift values to apply to the IOs.

Application of the method 700 to the memory 200 shown in FIG. 4 will now be described briefly to demonstrate that the method 700 produces a plurality of shift values representing the mappings 206a-f when provided with the shift redundancy pattern 402 and hints table 406 shown in FIG. 4.

The method 700 performs the initializations described above in steps 702-714. The method 700 assigns the value of shift redundancy pattern element 404a (namely, zero) to the variable current_SRP_val (step 716). Because both current_SRP_val and prev_SRP_val are equal to zero (step 718), the method 700 proceeds to step 720, in which the method 700 stores the value of default_shift (namely, zero) in element zero of the shift array 514. This correctly specifies the corresponding mapping 206a shown in FIG. 4, according to which the IO 204a is mapped to its default bit 202a without shifting by any bit positions.

The method 700 performs steps 722-724 and then repeats steps 716-724 two more times to store zero values in the next two elements of the shift array 514, thereby accurately reflecting the corresponding mappings 206b-c shown in FIG. 4.

When shift_index=3, however, the method 700 determines in step 718 that current_SRP_val is not equal to prev_SRP_val, as may be seen by the different values of shift redundancy pattern elements 404c and 404d in FIG. 4. The method 700 therefore proceeds to step 726. In the present example, max_shift=2, so the method 700 determines in step 726 that default_shift (which is equal to zero) is not greater than or equal to max_shift−1. The method 700 reads the value of the hints table element 408 (namely, one) and stores the value one in the variable current_hint (step 728).

In step 732 the method 700 calculates the value of default_shift+current_hint+1=0+1+1=2, and assigns the calculated value (2) to the variable default_shift (step 732). The method 700 increments the value of hint_index to a value of one (step 734).

The method 700 proceeds to step 720, in which the value of default_shift (namely, two) is assigned to the shift array element at index shift_index (namely, three). This accurately reflects the fact that the mapping 206d maps IO 204d to bit 202f, which is shifted by two bit positions with respect to IO 204d.

Because there are no additional functional-defective transitions in the shift redundancy pattern 402, the method 700 repeats steps 716-724 two more times, thereby storing the value two in the shift array 514 at indices 4 and 5. The resulting shift array 514 would have the sequence of values 000222, thereby accurately reflecting the mappings 206a-f between the memory bits 202a-h and the IOs 204a-f. It should therefore be appreciated that the method 700 may be used to decode the encoding 510 into a shift array which specifies the shifts to apply to the IOs 204a-f.

As previously mentioned, the hints table 520 may have any number of elements, each of which may be represented by any number of bits. Furthermore, different elements in the hints table 520 may be represented by different numbers of bits. In one embodiment, each elements in the hints table 520 is represented by the minimum number of bits necessary to represent that element.

More specifically, let N be the maximum number of contiguous defective bits that can be represented by a particular shift redundancy pattern. In one embodiment of the present invention, the N=2. In one embodiment of the present invention, the hints table 520 has at most N−1 elements.

It is not necessary for each element of the hints table 520 to be capable of representing a shift of N positions. To understand, consider for purposes of example the case in which N=3 (i.e., in which the encoding 510 is capable of encoding up to 3 contiguous defective bits). In such a case, each bit may be shifted by 0, 1, 2, or 3 positions.

When the first defective bit is encountered, it may be necessary to shift the next functional bit by 1, 2, or 3 positions. As a result, the corresponding element in the hints table 520 requires at least two bits because it must be capable of representing three different values (1, 2, or 3).

When the second defective bit is encountered, however, the next functional bit can only be shifted by 2 or 3 positions. In other words, the new default shift value may have a value of either 2 or 3. The new default shift value cannot be equal to 0 or 1 because the previous default shift value was equal to 1 and a new defective bit has been encountered, thereby necessitating that the new default shift value be greater than or equal to the old default shift value plus 1. Since second hints table entry therefore only needs to be capable of representing two possible values (2 or 3), only one bit is needed to represent it.

When the third defective bit is encountered, any remaining functional bits can only be shifted by 3 positions. As a result, no hint table entry is needed to discern between multiple possible shifts. Therefore, a hint table entry is not needed for the final one of N functional-defective transitions, which is why the hints table 520 need only include at most N−1, rather than N, entries.

The number of bits b required to represent the hints table entry at index j is given by Equation 1 and Equation 2:
b=ceil(log₂(N−j)) for 0≦j<N−1 Equation 1
b=0 for j=N−1 Equation 2

The ceil( ) function in Equation 1 rounds up its single argument to the closest integer. Example values of b for various values of N and j are shown in Table 1.

TABLE 1

| N | j | b |
|---|---|---|
| 2 | 0 | 1 |
| 2 | 1 | 0 |
| 3 | 0 | 2 |
| 3 | 1 | 1 |
| 3 | 2 | 0 |
| 4 | 0 | 2 |
| 4 | 1 | 2 |
| 4 | 2 | 1 |
| 4 | 3 | 0 |

The total number of bits required to implement a particular hints table may be ascertained by summing the values in the “b” column of Table 1 for the desired value of N. In other words, the total number of bits H required to implement a particular hints table is given by Equation 3:

$$H = {\sum }_{j = 0}^{N - 2} ceil ( {log}_{2} ( N - j ) ) \qquad Equation 3$$

For example, when N =2, the hints table 520 may be implemented with a total of H=1+0=1 bit; when N=3, the hints table 520 may be implemented with a total of H=1+2+0=3 bits; and when N=4, the hints table 520 may be implemented with a total of H=2+2+1+0=5 bits.

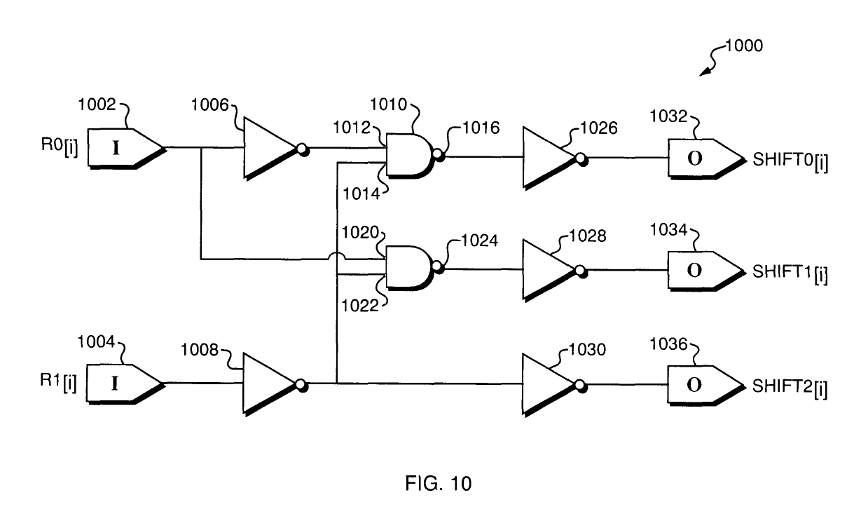

Referring to FIG. 8, a schematic diagram is shown of circuitry 800 for decoding one bit in the shift redundancy pattern 518 (FIG. 5) into an intermediate shift value signal according to one embodiment of the present invention. As described in more detail below with respect to FIG. 10, the intermediate shift value signal may be further decoded into a final shift value signal that may be applied by the shift engine 516 to the memory 502.

The particular embodiment illustrated in FIG. 8 may be used to decode the shift encoding 510 when the maximum permissible number of contiguous defective memory bits is 2 (i.e., when N=2). In such a case, the hints table 520 has a single element (as in the examples shown in FIGS. 3 and 4), referred to herein as HT[0].

In the embodiment illustrated in FIG. 8, the circuitry 800 decodes a bit at index i in the shift redundancy pattern 518. The intermediate shift value signal produced by the circuitry 800 includes a signal R1[i] (on line 826) and a signal R0[i] (on line 838). Although only the circuitry 800 is shown in FIG. 8 for ease of illustration and explanation, the circuitry 800 may be connected in series to other circuitry having the same structure. Each circuit in the series may encode a corresponding bit in the shift redundancy pattern 518 into an intermediate shift value signal. In particular, the signal R0[i] on line 838 may be provided at output 840 as an input to the next circuit in the series. As shown in FIG. 8, circuitry 800 receives a signal R0[i-1] at input 820 from the previous circuitry in the series (not shown).

In general, the circuitry 800 receives as input: (1) a single bit SRP[i] of the shift redundancy pattern 518 on line 842, (2) the single element HT[0] of the hints table 520 at input 814, and (3) the signal R0[i-1] at input 820. In response, the circuitry 800 produces the intermediate shift value signal consisting of signals R1[i] and R0[i] provided on lines 826 and 838, respectively.

The manner in which circuitry 800 produces signals R1[i] and R0[i] based on the inputs SRP[i], HT[0], and R0[i-1] will now be described. Referring to Table 2, the relationship among (1) SRP[i], R0[i-1]), and HT[0], (2) the corresponding final shift value signal (produced by circuitry 1000 shown in FIG. 10), and (3) the corresponding intermediate shift value signal is shown.

TABLE 2

| | | | Final Shift Value | |
|---|---|---|---|---|
| | | | Signal | |
| | | | (SHIFT0 [i], | Intermediate Shift |
| | | | SHIFT1 [i], | Value Signal |
| SRP [i] | R0 [i − 1] | HT [0] | SHIFT2 [i]) | (R1 [i], R0 [i]) |
| 0 | 0 | 0 | 0 | 00 |
| 0 | 0 | 1 | N/A | N/A |
| 0 | 1 | 0 | 2 | 11 |
| 0 | 1 | 1 | N/A | N/A |
| 1 | 0 | 0 | 1 | 01 |
| 1 | 0 | 1 | 2 | 11 |
| 1 | 1 | 0 | 1 | 01 |
| 1 | 1 | 1 | 2 | 11 |

As indicated by Table 2, the relationship between the final shift value signal and the intermediate shift value signal is as follows. A final shift value of zero bits corresponds to an intermediate shift value signal in which R0=0and R1=0; a final shift value of 1 bit corresponds to an intermediate shift value signal in which R0=1 and R1=0; and a final shift value of 2 bits corresponds to an intermediate shift value signal in which R0=1 and R1=1.

As shown in the first row of Table 2, when SRP[i], R0[i-1], and HT[0] are all equal to zero, the corresponding final shift value is also equal to zero. An example of this situation is the case in which i=0 in FIG. 3, as illustrated in FIG. 3 by the fact that the mapping 106a maps IO 104a to its default bit 102a (i.e., with a shift of zero).

The second and fourth rows of Table 2 specify values of SRP[i], R0[i-1] and HT[0] that will not occur when N=2. As a result, the corresponding final shift value in those rows is listed as “not applicable” (N/A).

As shown in the third row of Table 2, when SRP[i]=0, SRP[i-1]=1, and HT[0]=0, the corresponding final shift value is equal to 2. An example of this situation is the case in which i=4 in FIG. 3, as illustrated by the fact that the mapping 106e maps IO 104e to bit 102g, which is shifted from IO 104e by 2 bit positions.

Without going into further detail, the fifth row of Table 2 is exemplified by the case in which i=2 in FIG. 3; the sixth row of Table 2 is exemplified by the case in which i=3 in FIG. 4; the seventh row of Table 2 is exemplified by the case in which i=3 in FIG. 3; and the eighth row of Table 2 is exemplified by the case in which i=4 in FIG. 4.

Referring now to FIG. 8, the circuitry 800 includes a latch 808 that stores the value of a single bit of the shift redundancy pattern 518. Although the computer system 500 may include additional latches, one for each bit in the shift redundancy pattern, only the single latch 808 is shown in FIG. 8 for ease of illustration and explanation.

At system startup, a reset signal is provided at input 802 and transmitted on line 804 to input 805 of the latch 808. Data input 807 of latch 808 is wired to V_{DD.} As a result, the value of the latch 808 is initialized to zero when the reset signal is provided at clock input 805. A single bit SRP[i] of the shift redundancy pattern 518 is provided on line 842 and received by latch 808 at input 844. The single bit SRP[i] of the shift redundancy pattern 518 is output by the latch 808 at output 809.

Although the bit SRP[i] is shown in FIG. 8 as being provided to the latch 808 at a data input 844, this is not a requirement of the present invention. Alternatively, for example, the latch 808 may be scannable, in which case the bit SRP[i] may be serially shifted into the latch 808 (and the other latches, not shown, in the system 500) using a scan chain.

The circuitry 800 also includes multiplexers 812 and 830. The shift redundancy pattern bit output by latch 808 at output 809 is transmitted on line 810 to selection input 813 of multiplexer 812 and on line 828 to selection input 831 of multiplexer 830. The hints table element HT[0] is provided at input 814 and the previous shift redundancy pattern element SRP[i-1] is provided at input 820.

HT[0] is transmitted on line 816 and received by multiplexer 812 at data input 818. R0[i-1] (received from the previous circuit in the series) is transmitted on line 822 and received by multiplexer 812 at data input 824. Data input 834 of multiplexer 830 is coupled to V_{DD} over line 835. R0[i-1] is transmitted on line 832 and received by multiplexer 830 at data input 836.

Multiplexer 812 outputs a one-bit signal R1[i] at output 826, and multiplexer 830 outputs a one-bit signal R0[i] at output 838, which is provided at output 840. The signals R1[i] and R0[i] form a two-bit intermediate shift value signal, in which R1[i] is the most significant bit and R0[i] is the least significant bit.

The circuitry 800 produces appropriate values for R0[i] and R1[i] based on the inputted values of SRP[i], R0[i-1], and HT[0] as follows. First consider the case represented by the first row of Table 2, in which SRP[i]=0, R0[i-1]=0, and HT[0]=0. In this case, the SRP[i]=0 signal on multiplexer selection lines 810 and 828 causes the multiplexers 812 and 830 to output R1[i]=0 on line 826 and R0[i]=0 on line 838, as indicated in the “intermediate shift value signal” column of the first row of Table 2.

Next consider the case represented by the second row of Table 2, in which SRP[i]=0, R0[i-1]=1, and HT[0]=0. In this case, the SRP[i]=0 signal on multiplexer selection lines 810 and 828 causes the multiplexers 812 and 830 to output R1[i]=1 on line 826 and R0[i]=1 on line 838, as indicated in the “intermediate shift value signal” column of the second row of Table 2.

When SRP[i]=1, the multiplexer 830 will always output R0=1 on line 838 because the data input 834 of multiplexer 830 is tied to V_{DD}. This reflects the fact that R0=1 in rows 4-8 of Table 2, in which SRP[i]=1. Furthermore, when SRP[i]=1, the multiplexer 812 will output the value of HT[0] on line 838, because the data input 818 of multiplexer 812 is receives HT[0] on line 816. This reflects the fact that R1[i]=HT[0] in rows 4-8 of Table 2, in which SRP[i]=1.

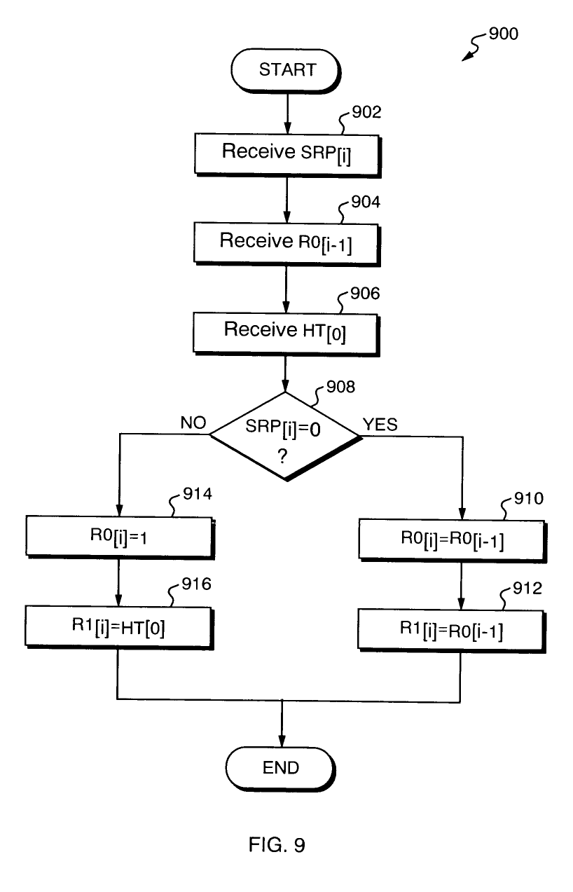

The discussion above explains how the circuitry 800 shown in FIG. 8 produces results in accordance with Table 2. Referring to FIG. 9, a flowchart is shown of a method 900 that is performed by the circuitry 800 in one embodiment of the present invention. The method 900 receives as inputs the values of SRP[i], R0[i-1], and HT[0] (steps 902-906). The method 900 determines whether SRP[i]=0 (step 908).

If the method 900 determines that SRP[i]=0, the method 900 assigns the value of R0[i-1] both to R0[i] and to R1[i] (steps 910-912). If the method 900 determines that SRP[i]≠0 (i.e., that SRP[i]=1), the method 900 assigns the value of 1 to R0[i] and the value of HT[0] to R1[i] (steps 914 and 916). The manner in which the circuitry 800 performs the method 900 should be apparent from Table 2 and from the preceding discussion of FIG. 8.

Referring to FIG. 10, a schematic diagram is shown of circuitry 1000 for translating the intermediate shift value signal provided at inputs 1002 and 1004 into a final shift value signal consisting of three signals SHIFT0[i], SHIFT1[i], and SHIFT2[i], at outputs 1032, 1034, and 1026, respectively. It should be appreciated that although the circuitry 1000 shown in FIG. 10 translates a single intermediate shift value signal into a single final shift value signal, the system 500 may include additional circuitry that operates in the same manner as circuitry 1000 to translate additional intermediate shift value signals into additional final shift value signals. The relationship between the inputs 1002 and 1004 (R0[i] and R1[i]) and outputs 1032, 1034, and 1026 (SHIFT0[i], SHIFT1[i], and SHIFT2[i]) of circuitry 1000 is shown in Table 3, below.

TABLE 3

| R1 [i] | R0 [i] | SHIFT0 [i] | SHIFT1 [i] | SHIFT2 [i] |
|---|---|---|---|---|
| 0 | 0 | 1 | 0 | 0 |
| 0 | 1 | 0 | 1 | 0 |
| 1 | 1 | 0 | 0 | 1 |

As may be seen from Table 3, a high value of SHIFT0[i] indicates a shift value of 0, a high value of SHIFT1[i] indicates a shift value of 1, and a high value of SHIFT2[i] indicates a shift value of 2. The signals SHIFT0[i], SHIFT1[i], and SHIFT2[i] may, for example, be provided as selection signals for 3-input multiplexers (not shown), as described in more detail in the above-referenced patent application entitled “Repair Techniques for Memory with Multiple Redundancy.” In this way, the circuitry 1000 may be used to electrically connect input/output ports in the memory 502 to corresponding functional bits in the memory 502, and thereby to implement the mappings specified by the shift encoding 510.

To understand how the circuitry 1000 produces the correct outputs based on its inputs, consider first the case in which R0[i]=0 and R1[i]=0 (corresponding to the first row of Table 3). Input 1002 (R0[i]) is coupled to input 1012 of NAND gate 1010 through inverter 1006. Input 1004 (R1[i]) is coupled to input 1014 of NAND gate 1010 through inverter 1008. Since R0[i]=0 and R1[i]=0, the NAND gate 1010 outputs a logical 1 at output 1016. The output of NAND gate 1010 is coupled to inverter 1026, which produces a logical 0 at output 1032 (SHIFT0 [i]).

Input 1002 (R0[i]) is coupled to input 1020 of NAND gate 1018, while input 1004 (R1[i]) is coupled to input 1022 of NAND gate 1018 through inverter 1008. Since the NAND gate 1018 receives a 0 and 1 at its inputs 1020 and 1022, respectively, it outputs a logical 1 at its output 1024. The output of NAND gate 1018 is coupled to inverter 1028, which produces a logical 0 at output 1034 (SHIFT1[i]).

Finally, input 1004 (R1[i]) is coupled to output 1026 (SHIFT2[i]) through inverters 1008 and 1030. Since R1[i]=0, the inverter 1030 produces a logical 0 at output 1026 (SHIFT2[i]). It may therefore be appreciated that the circuitry 1000 produces the correct values of 1, 0, and 0,respectively, for outputs 1032 (SHIFT0[i]), 1034 (SHIFT1[i]), and 1026 (SHIFT2[i]), when R0[i9 =0 and R1[i]=1, as shown in Table 3. The operation of the circuitry 1000 may similarly be verified to produce outputs in accordance with Table 3 when R0[i]=1 and R1[i]=0, and when R0[i]=1 and R1[i]=1.

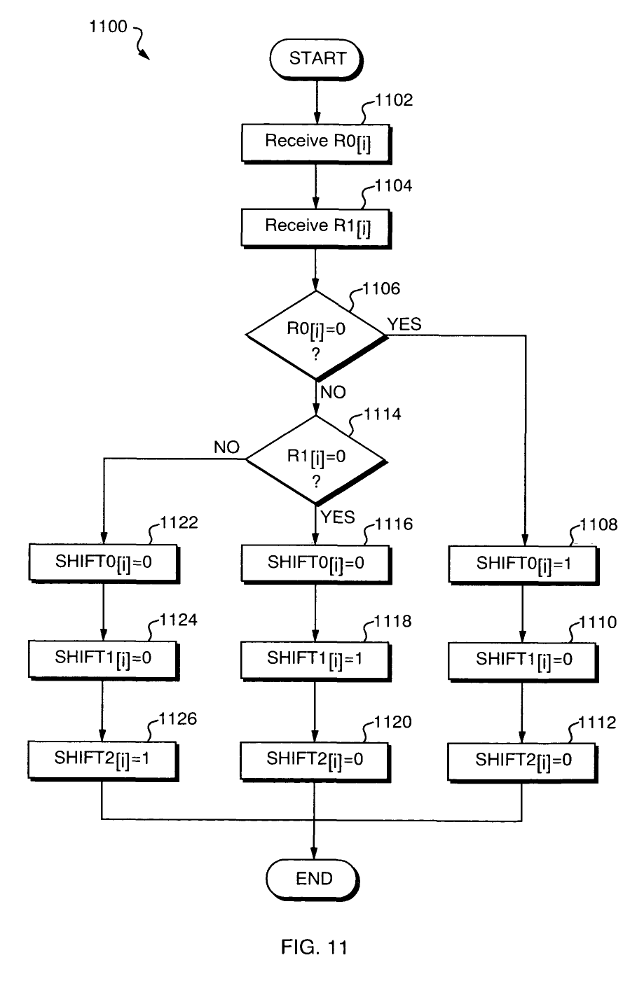

The discussion above explains how the circuitry 1000 shown in FIG. 10 produces results in accordance with Table 3. Referring to FIG. 11, a flowchart is shown of a method 1100 that is performed by the circuitry 1000 in one embodiment of the present invention. The method 1100 receives as inputs the values of R0[i] and R1[i] (steps 1102-1104). The method 900 determines whether R0[i]=0 (step 1106). If R0[i]=0, the method 1100 sets the values of SHIFT0[i], SHIFT1[i], and SHIFT2[i] to 1, 0, and 0, respectively (steps 1108-1112), reflecting the first row of Table 3.

If the method 1100 determines that R0[i] is not equal to 0 (i.e., that R0[i]=1), the method 1100 determines whether R1[i]=0 (step 1114). If R1[i]=0, the method 1100 sets the values of SHIFT0[i], SHIFT1[i], and SHIFT2[i] to 0, 1, and 0, respectively (steps 1116-1120), reflecting the second row of Table 3.

Finally, if the method 1100 determines that R1[i] is not equal to 0 (i.e., that R1[i]=1), the method 1100 sets the values of SHIFT0[i], SHIFT1[i], and SHIFT2[i] to 0, 0, and 1, respectively (steps 1122-1126), reflecting the third row of Table 3. The manner in which the circuitry 1000 performs the method 1100 should be apparent from Table 3 and from the preceding discussion of FIG. 10.

Among the advantages of the invention are one or more of the following.

One advantage of various embodiments of the present invention is that they enable shift redundancy patterns to be represented using fewer bits, and therefore to be implemented using fewer serial shift elements, than in the prior art. Consider, for example, a design with 900 bits of memory that require shifting by up to 4 positions (N=4). The prior art direct encoding scheme described above would require 3000 shift elements (3 per bit) to implement such a design. The Barth scheme could be used to reduce the number of shift elements to 900, and thereby reduce the shift time by 67 percent. The Barth scheme, however, would not be able to handle consecutive defective bits.

Using techniques disclosed herein, 1005 serial shift elements could be used (1 shift element per bit for the shift redundancy pattern 518 and 5 shift elements for the hints table 520) to handle anywhere between 0 and 4 contiguous defective bits. Such an approach would produce a reduction in the time required to transmit (serially shift) the pattern that is nearly indistinguishable from that provided by the Barth scheme, but without being limited to non-contiguous defects.

In addition to providing faster shift times than the direct encoding method and being able to handle contiguous defective bits, techniques disclosed herein may reduce the volume and cost of the memory repair hardware in comparison to the hardware required to implement the direct encoding method.

The techniques disclosed herein also provide design flexibility to those designing memory repair systems. Because of the generality of the approach disclosed herein, designers may select an initial value for N (the maximum permissible number of contiguous defective bits) and then identify the size and structure of the corresponding hints table using Equation 1 and Equation 2. The designer may use this information to estimate the size, cost, and speed of the resulting memory repair circuitry and thereby select a final value of N that produces a system having the desired tradeoff between size, cost, and speed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Elements and components described herein may be further divided into additional components or joined together to form fewer components for performing the same functions.

Although the memory input/output ports described in various examples above may be referred to as “IOs,” the present invention is not limited to use in conjunction with IOs. Rather, embodiments of the present invention may be used in conjunction with other kinds of interfaces between memory elements and devices (such as processors) that access such memory elements.

The shift redundancy pattern 518 and hints table 520 may be implemented in any of a variety of tangible forms, such as by storing them in a fuse block and/or a plurality of latches, as described above. These are merely examples, however, and do not constitute limitations of the present invention. Furthermore, no limitation is intended by the use of the term “pattern” to describe the shift redundancy pattern 518 and the use of the term “table” to describe the hints table 520. Rather, the shift redundancy pattern 518 and hints table 520 may be implemented in any kind of signal and/or electronic data record.

The techniques described above may be implemented, for example, in hardware (e.g., analog and/or digital circuitry), software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

1. A computer-implemented method for use in a computer system including a memory, the memory including a plurality of bits at a plurality of positions, the method comprising steps of:
(A) identifying the position of a bit in a set of n consecutive defective bits in the memory;
(B) generating an entry in a shift redundancy record indicating that the bit identified in step (A) is defective; and
(C) generating a hint record indicating the number n of bits in the set of consecutive defective bits.

2. The method of claim 1, wherein n=1.

3. The method of claim 1, wherein n=2.

4. The method of claim 1, wherein step (A) comprises a step of identifying a defective bit that is adjacent to a functional bit in the memory; and wherein the method further comprises a step of:
(D) performing steps (A)-(C) for a plurality of sets of consecutive defective bits in the memory.

5. The method of claim 1, wherein the step (B) comprises a step of generating a single-bit entry in the shift redundancy record indicating that the bit identified in step (A) is defective.

6. The method of claim 1, wherein the memory further comprises a plurality of input/output ports for accessing the plurality of bits, and wherein the method further comprises steps of:
(D) controlling switching circuitry to disconnect the set of n consecutive defective bits from the input/output ports.

7. The method of claim 1, wherein step (C) comprises a step of generating a hint record representing the value n−1.

8. A computer-implemented method for use in a computer system including a memory, the memory including a plurality of bits at a plurality of positions and a plurality of input/output ports for accessing the plurality of bits, the method comprising steps of:
(A) identifying the position of a bit in a set of n consecutive defective bits in the memory, wherein the identified is adjacent to a functional bit in the memory;
(B) generating a single-bit entry in a shift redundancy record indicating that the bit identified in step (A) is defective;
(C) generating a hint record representing the value n−1;
(D) performing steps (A)-(C) for a plurality of sets of consecutive bits in the memory; and
(E) controlling switching circuitry to disconnect the set of n consecutive defective bits from the input/output ports.

9. An apparatus for use in a computer system including a memory, the memory including a plurality of bits at a plurality of positions, the apparatus comprising:
means for identifying the position of a bit in a set of n consecutive defective bits in the memory;
means for generating an entry in a shift redundancy record indicating that the bit identified in step (A) is defective; and
means for generating a hint record indicating the number n of bits in the set of consecutive defective bits.

10. The apparatus of claim 9, wherein the means for generating comprises means for generating a single-bit entry in the shift redundancy record indicating that the bit identified by the means for identifying is defective.

11. The apparatus of claim 9, wherein the memory further comprises a plurality of input/output ports for accessing the plurality of bits, and wherein the apparatus further comprises:
means for controlling switching circuitry to disconnect the set of n consecutive defective bits from input/output ports.

12. The apparatus of claim 9, wherein the means for generating comprises means for generating a hint record representing the value n−1.

13. A computer-implemented method for use in a computer system including a memory, the memory including a plurality of bits at a plurality of positions, wherein b[i] refers to the bit at position i in the plurality of bits, the method comprising steps of:
(A) selecting a first value for a current shift redundancy record variable, wherein the current shift redundancy record value may be toggled between the first value and a second value;
(B) for each of a plurality of consecutive values of i, performing steps of:
(1) if bit b[i] is defective and bit b[i-1] is functional, performing steps of:
(a) toggling the value of the current shift redundancy record variable;
(b) identifying a set of n consecutive defective bits including bit b[i];
(c) storing a hint value in a hints record entry corresponding to bit b[i], the hint value indicating the number n; and
(2) storing the current shift redundancy record value in a shift redundancy record element corresponding to bit b[i].

14. The method of claim 13, wherein n=1.

15. The method of claim 13, wherein n=2.

16. The method of claim 13, wherein the step (B)(2) comprises a step of storing a single-bit value in the shift redundancy record representing the position of bit b[i].

17. The method of claim 13, wherein the step (B)(1) further comprises a step of:
(B)(1)(d) controlling switching circuitry to disconnect the set of n consecutive defective bits from input/output ports of the memory.

18. The method of claim 13, wherein the hint value is equal to n−1.

19. A computer-implemented method for use in a computer system including a memory, the memory including a plurality of bits at a plurality of positions, wherein b[i] refers to the bit at position i in the plurality of bits, the method comprising steps of:
(A) selecting a first value for a current shift redundancy record variable, wherein the current shift redundancy record value may be toggled between the first value and a second value;
(B) for each of a plurality of consecutive values of i, performing steps of:
(1) if bit b[i] is defective and bit b[i-1] is functional, performing steps of:
(a) toggling the value of the current shift redundancy record variable;
(b) identifying a set of n consecutive defective bits including bit b[i];
(c) storing a hint value representing the value n−1 in a hints record entry corresponding to bit b[i];
(d) controlling switching circuitry to disconnect the set of n consecutive defective bits from input/output ports of the memory; and
(2) storing the current shift redundancy record value in a single-bit shift redundancy record element corresponding to bit b[i].

20. An apparatus for use in a computer system including a memory, the memory including a plurality of bits at a plurality of positions, wherein b[i] refers to the bit at position i in the plurality of bits, the apparatus comprising:
means for selecting a first value for a current shift redundancy record variable, wherein the current shift redundancy record value may be toggled between the first value and a second value;
for each of a plurality of consecutive values of i:
means for toggling the value of the current shift redundancy record variable if bit b[i] is defective and bit b[i-1] is functional;
means for identifying a set of n consecutive defective bits including bit b[i] if bit b[i] is defective and bit b[i-1] is functional; and
means for storing a hint value in a hints record entry corresponding to bit b[i], the hint value indicating the number n; and
means for storing the current shift redundancy record value in a shift redundancy record element corresponding to bit b[i].

21. The apparatus of claim 20, wherein the means for the current shift redundancy record value comprises means for storing a single-bit value in the shift redundancy record representing the position of bit b[i].

22. The apparatus of claim 20, further comprising:
means for controlling switching circuitry to disconnect the set of n consecutive defective bits from input/output ports of the memory.

23. A computer system comprising:
a memory comprising a plurality of bits and a plurality of input/output ports for accessing the plurality of bits;
a memory defect map specifying positions of defective ones of the plurality of bits; and
a shift encoder for encoding positions of defective ones of the plurality of bits in a shift encoding, the shift encoding comprising:
a shift redundancy record representing positions of transitions between functional bits and defective bits in the memory; and
a hints record representing numbers of bits in sets of consecutive defective bits in the memory.

24. The method of claim 23, wherein the shift redundancy record comprises a plurality of shift redundancy record elements corresponding to the plurality of input/output ports.

25. The method of claim 24, wherein each of the plurality of shift redundancy record elements comprises a single-bit value.

26. The method of claim 23, wherein the number of bits in the hints record is equal to H, wherein the value of H is given by the following equation:
$$H = {\sum }_{j = 0}^{N - 2} ceil ( {log}_{2} ( N - j ) ) ,$$
wherein N is a maximum permitted number of consecutive defective bits in the memory, and wherein the ceil( ) function rounds up its single argument to the closest integer.

27. A computer-implemented method for use in a computer system including a memory, the memory including a plurality of bits and a plurality of input/output ports for accessing the plurality of bits, the method comprising steps of:
(A) receiving a shift encoding that encodes positions of defective ones of the plurality of bits, the shift encoding comprising:
a shift redundancy record that encodes transitions between functional bits and defective bits in the memory; and
a hints record that encodes numbers of bits in sets of consecutive defective bits in the memory; and
(B) generating, based on the shift encoding, a plurality of shift values that specify mappings between the plurality of input/output ports and corresponding ones of the plurality of bits.

28. The method of claim 27, wherein the plurality of bits have a plurality of consecutive positions within the memory, wherein b[i] refers to the bit at position i in the memory, wherein the hints record comprises at least one hints record element, and wherein step (B) comprises steps of:
(B)(1) identifying a position i for which bit b[i] is defective and bit b[i-1] is functional;
(B)(2) identifying a hints record element in the hints record that corresponds to bit b[i]; and
(B)(3) generating a select one of the plurality of shift values based on the hints record element identified in step (B)(2).

29. The method of claim 28, wherein the hints record element identified in step (B)(2) has a hint value, and wherein the step (B)(3) comprises a step of assigning the hint value plus one to the select one of the plurality of shift values.

30. The method of claim 28, wherein the hints record element identified in step (B)(2) has a hint value, wherein the step (B) further comprises a step of identifying a previous shift value, and wherein the step (B)(3) comprises a step of assigning the previous shift value plus the hint value plus one to the select one of the plurality of shift values.

31. The method of claim 27, wherein the shift redundancy record includes a plurality of shift redundancy values, wherein SRP[i] refers to a shift redundancy value having index i in the plurality of shift redundancy values, and wherein the step (B) comprises steps of:
(1) selecting an initial shift value for a default shift variable;
(2) selecting as a current hints record element an initial hints record element having an initial hint value;
(3) for each of a plurality of consecutive values of i, performing steps of:
(a) if SRP[i] is not equal to SRP[i-1], performing steps of:
(i) adding one plus a value of the current hints record element to the value of the default shift variable to produce a new value for the default shift variable; and
(ii) selecting as the current hints record element a next hints record element having a next hint value; and
(b) generating a shift value in the plurality of shift values that is equal to the value of the default shift variable.

32. The method of claim 27, wherein the number of bits in the hints record is equal to H, wherein the value of H is given by the following equation:
$$H = {\sum }_{j = 0}^{N - 2} ceil ( {log}_{2} ( N - j ) ) ,$$
wherein N is a maximum permitted number of consecutive defective bits in the memory, and wherein the ceil( ) function rounds up its single argument to the closest integer.

33. A computer system comprising:
a memory comprising a plurality of bits and a plurality of input/output ports for accessing the plurality of bits, wherein IO[i] refers to an input/output port at position i;
a plurality of stored shift redundancy record signals representing shift values for the plurality of I/O ports, wherein SRP[i] refers to a shift redundancy record signal for input/output port IO[i];
a stored hints record signal representing the number of bits in a set of consecutive defective bits in the memory;
a first multiplexer comprising a first data input receiving the stored hints record signal, a second data input receiving a signal R0[i-1], a selection input receiving signal SRP[i], and an output providing a signal R1[i]; and
a second multiplexer comprising a first data input receiving a signal having a predetermined voltage level, a second data input receiving signal R0[i-1], a selection input receiving SRP[i], and an output providing a signal R0[i].

34. The computer system of claim 33, wherein the predetermined voltage level comprises a high logical voltage level.

35. The computer system of claim 33, further comprising:
a first inverter comprising an input receiving signal R0[i] and an output providing a first inverted signal;
a second inverter comprising an input receiving signal R1[i] and an output providing a second inverted signal;
a first NAND gate comprising a first input coupled to the output of the first inverter, a second input coupled to the output of the second inverter, and an output providing a first NAND signal;
a second NAND gate comprising a first input receiving signal R0[i], a second input coupled to the output of the second inverter, and an output providing a second NAND signal;
a third inverter coupled to the output of the first NAND gate and an output providing a signal SHIFT0;
a fourth inverter coupled to the output of the second NAND gate and an output providing a signal SHIFT1; and
a fifth inverter coupled to the output of the third NAND gate and an output providing a signal SHIFT2.

36. The computer system of claim 33, wherein the number of bits in the stored hints record signal is equal to H, wherein the value of H is given by the following equation:
$$H = {\sum }_{j = 0}^{N - 2} ceil ( {log}_{2} ( N - j ) ) ,$$
wherein N is a maximum permitted number of consecutive defective bits in the memory, and wherein the ceil( ) function rounds up its single argument to the closest integer.
